(19) United States
(12) Patent Application Publication
(10) Pub. No.: US 2007/0282519 A1
(43) Pub. Date: Dec. 6, 2007

(54) SYSTEM AND METHOD FOR ANALYZING TRAFFIC DISTURBANCES REPORTED BY VEHICLES

(76) Inventors: Ossama Emam, Giza (EG); Dimitri Kanevsky, Ossining, NY (US)

Correspondence Address: HOFFMAN, WARNICK & D'ALESSANDRO LLC, 75 STATE ST, 14 FL, ALBANY, NY, 12207, US

(21) Appl. No.: 11/695,715

(22) Filed: Apr. 3, 2007

(30) Foreign Application Priority Data
Jun. 2, 2006 (EP) 06114943.1

(51) Int. Cl. G06G 7/76

(52) U.S. Cl. 701/117

(57) ABSTRACT

A method, system and computer program product for collecting, analyzing and handling abnormal situations or abnormal vehicle behaviors encountered on a road by at least one vehicle. The method includes: receiving at least one report from at least one originator, each report corresponding to at least one abnormal situation or abnormal vehicle behavior encountered by a vehicle on the road; for each received report: for each reported abnormal situation: characterizing the abnormal situation according to a situation type based on information and measurements contained in the report; identifying and localizing the abnormal situation from information contained in the report; taking an appropriate action in order to handle the abnormal situation based on: the situation type, the localization of the abnormal situation and previous reports related to the abnormal situation, if any, received during a given time period; for each reported abnormal vehicle behavior: characterizing the abnormal vehicle behavior according to a behavior type based on information and measurements contained in the report; identifying the vehicle or a driver of the vehicle having the abnormal behavior from information contained in the report; taking an appropriate action based on: the behavior type, previous reports, if any, received during a given time period and concerning the same vehicle or driver; recording the report.

### FIELD OF THE INVENTION

The present invention relates to the field of security in vehicles and, more particularly, to a system, method, and computer program product for reporting abnormal situations observed on the road, based on the use in each vehicle of an embarked camera and a voice interactive system. The reported data is collected and analyzed in a central traffic management system in order to take appropriate actions.

### BACKGROUND OF THE INVENTION

Drivers or passengers sometimes observe that some cars do not obey the highway code. For example, cars may cross the center line, may overtake a car despite a car arriving from the opposite direction, may cross a street while the traffic light is red, or may significantly exceed the speed limit. The behavior of these drivers often remains unpunished by the police and may lead to serious accidents. Such incidents are especially dangerous for drivers who systematically don't respect the driving rules on the road (e.g., drunk drivers or teenagers).

Some systems, such as automatic speed detectors placed along a road, can detect dangerous behaviors at the wheels. However, these detectors are not installed everywhere and they do not detect other driving problems. Cameras can also be installed at some crossroads to capture and record abnormal events. Such records can be used by insurance companies and the police if a traffic accident occurs. Unfortunately, these systems do not prevent accidents by identifying drivers who systematically don't respect the highway code. It is necessary to create a system able to detect such abnormal situations on the road, to identify such drivers, and to report the information to the authorities responsible for the traffic.

### SUMMARY OF THE INVENTION

The present invention allows a driver of a vehicle to express his/her concerns about traffic conditions and to report information related to these concerns to a server. Further, the present invention can be used to:
(a) report to a central system abnormal situations observed on the road;
(b) detect on the road a driver with an abnormal behavior;
(c) identify other vehicles on the road;
(d) locate a vehicle by means of a navigation system;
(e) verify that observations about disturbances on the road are correct;
(f) use sensors to measure and record abnormal events (e.g., speed, distance, traffic light etc.); and
(g) inform the driver about the disturbances detected on the road.

The present invention is directed to a method, system, and computer program product for collecting, analyzing, and handling abnormal situations or abnormal vehicle behaviors encountered on the road by one or a plurality of vehicles.

A method in accordance with an aspect of the invention comprises: receiving at least one report from at least one originator, each report corresponding to at least one abnormal situation or abnormal vehicle behavior encountered by a vehicle on the road; for each received report: for each reported abnormal situation: characterizing the abnormal situation according to a situation type based on information and measurements contained in the report; identifying and localizing the abnormal situation from information contained in the report; taking an appropriate action in order to handle the abnormal situation based on: the situation type, the localization of the abnormal situation and previous reports related to the abnormal situation, if any, received during a given time period; for each reported abnormal vehicle behavior: characterizing the abnormal vehicle behavior according to a behavior type based on information and measurements contained in the report; identifying the vehicle or a driver of the vehicle having the abnormal behavior from information contained in the report; taking an appropriate action based on: the behavior type, previous reports, if any, received during a given time period and concerning the same vehicle or driver; recording the report.

The foregoing, together with other aspects, features, and advantages of this invention can be better appreciated with reference to the following specification, claims, and drawings.

### BRIEF DESCRIPTION OF THE DRAWINGS

Various embodiments for implementing the present invention will be described below in detail with reference to the accompanying drawings. The embodiments, however, are not intended to restrict the invention according to the claims, and all combinations of features described in the embodiments are not necessarily required as solving means for the invention.

FIG. 1 depicts the operation of an illustrative system in accordance with an embodiment of the present invention.

FIG. 2 shows various components of an illustrative reporting mechanism according to an embodiment of the present invention.

FIG. 3 shows various components of an illustrative remote traffic opinion server according to an embodiment of the present invention.

FIG. 4 shows processes carried out by an illustrative method according to an embodiment of the present invention.

### DETAILED DESCRIPTION OF THE INVENTION

The following description is presented to enable one or ordinary skill in the art to make and use the invention and is provided in the context of a patent application and its requirements. Various modifications to the principles and features described herein will be readily apparent to those skilled in the art. Thus, the present invention is not intended to be limited to the embodiment(s) shown but is to be accorded the widest scope consistent with the principles and features described herein.

The present invention relates to a system, method, and computer program product for allowing the driver or passengers of a vehicle to report abnormal situations observed with regard to other vehicles when such situations are detected. In an embodiment of the invention, the system comprises a voice interactive system and a camera to facilitate the reporting of such incidents. Further, the present invention relates to a central traffic management system for collecting and analyzing the data reported from one or a plurality of vehicles in order to take appropriate actions.

It is well known that when a driver encounters traffic problems, he/she often becomes nervous. In an embodiment of the present invention, the system according to the present invention also comprises some means to relax the driver. For instance, the system can calm the driver by playing music or interactively talking with the driver.

It is also possible to use biometrics sensors to detect the stress level of the driver. The detection of dangerous situations involving other vehicles combined with the measure of the stress level of the driver may help to find means capable to relax the driver.

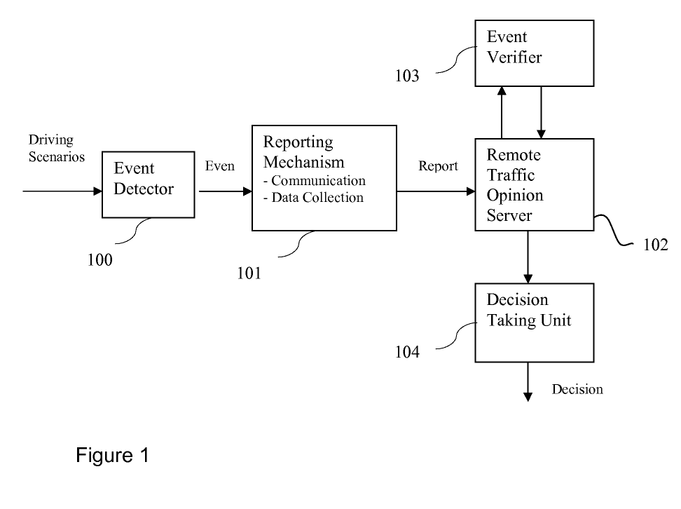

FIG. 1 depicts the operation of an illustrative system in accordance with an embodiment of the present invention.

Surrounded by different “driving scenarios,” a driver may face dangerous situations involving other vehicles which don't respect the highway code. For example, a car may cross a white line or may overtake a car despite a car arriving from the opposite direction. A car may cross a street with a red traffic light or may exceed a speed limit.

The function of the event detector 100, as shown in FIG. 1, is to detect such abnormal and dangerous situations. The event detector 100, which can be a system installed in the car of a driver, includes speed sensors and distance sensors. The event detector 100 can also be the driver him/herself.

An example of an event detector 100 is described in U.S. Pat. No. 6,792,339 to Basson et al., entitled “Artificial Passenger with condition sensors,” which is incorporated in its entirety herein by reference. This patent discloses a situation controller for a vehicle. The situation controller includes a processing device and an image monitor coupled to the processing device, for monitoring images associated with one or more items within the vehicle. The situation controller also includes a device for communicating a message relating to the one or more monitored items wherein the content of the message is determined by the processing device based at least in part on the one or more monitored items. Additionally, a controller coupled to the processing device, for controlling at least one function of the vehicle in response to the one or more monitored items within the vehicle, is included.

The present invention requires the use of a similar system, but directed to events outside the vehicle.

Once an event is detected by the event detector 100, a reporting mechanism 101 is used to report this event. The reporting mechanism 101 includes a communication system for communicating a report. The report can be done either immediately by means of wireless communication available in the car, or it can be done “off line” when the car is stopped at a gas station or in a garage using, for example, a local communication network.

The report can be downloaded on a user mobile device (e.g., a PDA, a cellular phone, etc.). Then, when the user connects this mobile device to a computer in an office or at home, the data can be sent to one or more specific destinations. It is useful to have communication system adapted to different situations. For example, in some rural areas, it may be impossible to transmit data immediately using wireless communication. In this case, the report can be recorded inside the car and transmitted later when a suitable communication system becomes available.

The reporting mechanism 101 further includes a data collection system for selecting the data which will be sent in the report. The selected data can include simple information, for instance, a user voice description of what happened—“the car with XXXX number almost hit my car,” or can be more sophisticated, and include information such as the position of the car measured by a GPS (Global Positioning System), pictures of the car, and sensor measurements (e.g., distance, speed, etc.).

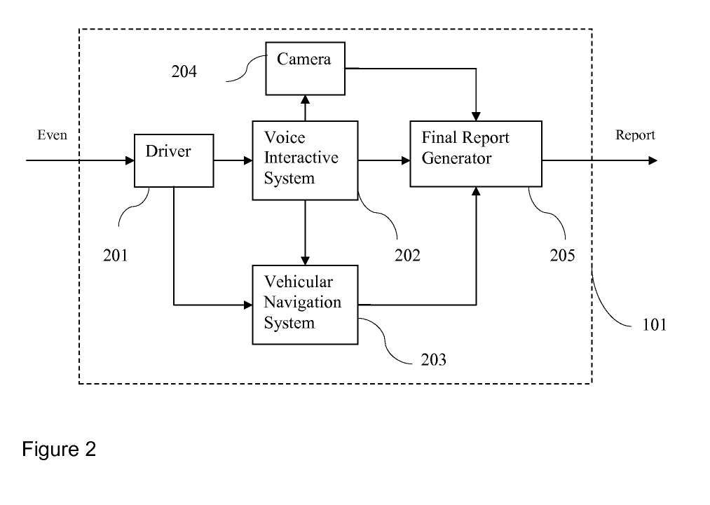

FIG. 2 shows the various components of a reporting mechanism 101 in accordance with an embodiment of the present invention. As shown, the reporting mechanism 101 can include a voice interactive system 202. The driver 201 can use a voice interactive system such as that disclosed in U.S. Pat. No. 6,236,968 to Kanevsky et al., entitled “Sleep prevention dialog based car system,” which is incorporated in its entirety herein by reference, to record his/her comments (e.g., “The car with the identification number XXXX significantly exceeds the speed limit”).

The reporting mechanism 101 can also include a camera 204. The driver 201 can refer to the content being recorded by the camera 204 placed in/on the car in his/her comments. An example of a suitable camera is disclosed in U.S. Pat. No. 6,792,339 to Basson et al., entitled “Artificial passenger with condition sensors,” which is incorporated in its entirety herein by reference. The camera 204 can be directed toward the car in question to record the situation that disturbs the driver 201. In this case the driver 201 can say something like: “The red car which is on the left side of my car significantly exceeds the speed limit.”

In some situations, the driver 201 may not have sufficient time to read the identification number of the car that disturbs him/her. The driver 201 mau need other tools to accomplish this. One such tool is a vehicular navigation system 203. An example of a suitable vehicular navigation system 203 is described in U.S. Pat. No. 6,919,866 to Karenvsky et al., entitled “Vehicular Navigation System,” which is incorporated in its entirety herein by reference. This type of vehicular navigation system uses an optical arrangement installed in eyeglasses or on a vehicle window or windshield so as to impart improved guiding directions to the vehicle. The vehicular navigation system enables a user to display their geographic coordinates through the intermediary of a Global Positioning System (GPS) which communicates with a computer of the system. An additional element to current GPS, utilizes an optical system located either on the windshield of a vehicle, such as an automobile or truck, or on the eyeglasses of a driver, or possibly on the windshield of an aircraft, which mimics an arrow pointing in the direction in the driver should be traveling. This system includes control means in the form of a mouse for operating the system, which are mounted on a steering wheel. This mouse allows the driver 201 to point to a car that he/she found disturbing via a virtual arrow in a windshield to capture information (e.g., a picture of a car, GPS, etc.).

The reporting mechanism 101 can also include a final report generator 205. Voice comments (e.g., provided by the driver 201) and/or images (e.g., provided by the camera 204) are transmitted to the final report generator 205, which prepares the final report. This report comprises, in addition to the driver comments and images of the event, other relevant information that can be captured automatically (e.g., the date, the time of the event, the place and position of the car using a GPS, etc.).

As shown in FIG. 1, the final report is sent to a central point or remote traffic opinion server 102. The remote traffic opinion server 102 receives reports from different drivers about different events and uses an event verifier 103 to verify that the car has not respected the highway code and created disturbances. For example, the event verifier 103 verifies whether or not the car has really exceeded the speed limit or has crossed a center line too close to the driver's car arriving from the opposite direction. The event verifier 103 can use the measurements provided by the speed sensors, distance sensors, and GPS to verify the driver's comments.

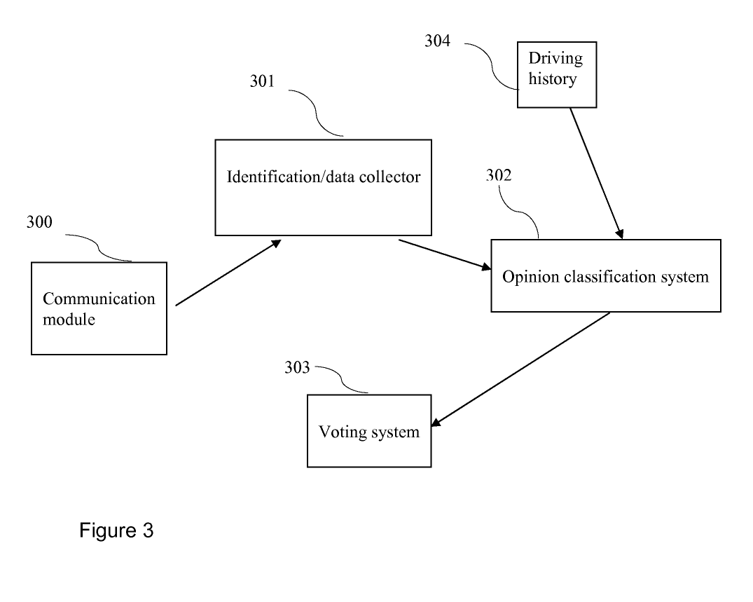

FIG. 3 shows the various components of an illustrative remote traffic opinion server 102.

The remote traffic opinion server 102 comprises a communication module 300 to receive data from various mobile devices embarked in cars (e.g., cellular phones, car communication systems, etc.) as well as from other communication systems located in particular places (e.g., in garages, gas stations, etc.). The communication module 300 can also receive data from the Internet when drivers connect their mobile devices to computers at homes or in offices.

The identification/data collector 301 collects different kinds of data received from the same person at different times. First, the identification/data collector 301 checks that the data is received from the same person and classifies this data. The user identification can be done in various ways:
(a) the user identifies himself/herself explicitly (e.g., tells his/her name);
(b) the car from which data are sent is identified (identification or the communication system used in the car); and
(c) the speaker is identified using voiceprint (if the driver transmits the information orally).

The identification/data collector 301 classifies the data by category:
(a) audio data, video data, GPS data, distance data, speed data, etc.;
(b) data from the same person or from different persons in the same car (e.g., if passengers speak);
(c) data related to the same car or to different cars;
(d) data related to the same car but at different times; and
(e) other factors.

Different kinds of data may use different processing and analyzing methods. For example, audio data is processed by automatic speech recognition and text processing systems (like summarization, translation, etc.), video data uses image recognition systems (to detect some images, for example, a car color or registration plate number).

The identification/data collector 301 may comprise a speech and language processing server using natural language processing means to recognize sentences from a driver like: “This car again has crossed my line in front of me as it did two days ago.” Semantic tools allowing the processing of complex sentences are described, for example, in U.S. Pat. No. 6,236,968, entitled “Sleep prevention dialog based car system,” which is incorporated in its entirety herein by reference.

The identification/data collector 301 may also comprise image processing means (such as image recognition means) to recognize visual objects sent to the remote traffic opinion server 102 (e.g., as cars, trees, people, animals, buildings, streets, etc.).

It may also be useful to identify a dangerous place rather than a driver. For example, it may be very useful to detect rocks that have fallen from a mountain on a road and to warn drivers about this situation. In this particular case, the warning does not relate to a driver or a car but to a dangerous situation.

The opinion classification system 302 puts the different opinions reported by a particular driver into different categories (e.g., reckless, inexperienced behavior at wheel, etc.) and characterizes the abnormal situations that are reported according to predefined types (e.g., exceeding a speed limit, crossing a street when the light is red, crossing a center line, overtaking a car without visibility, etc.).

A similar opinion can be provided by the driver about a particular place (when for instance this place is dangerous). In order to characterize an abnormal situation, the opinion classification system 302 can use different examples of situations stored in a driving history database 304.

A method of classifying different driving behaviors by similarity is disclosed in U.S. Pat. No. 6,505,208 to Kanevsky et al., entitled “Educational monitoring method and system for improving interactive skills based on participants on the network,” which is incorporated in its entirety herein by reference. This system recommends to users, a most efficient manner of accomplishing tasks achievable by computing devices. The system detects command sequences executed by users during an interaction with computing devices distributed over a network in an attempt to achieve a certain goal. The command sequences are segmented, each segment is labeled with a goal identifying purpose mark, and a cost of each segment is computed. The detected command sequences are then compared with the command sequences detected previously and the descriptions of the more efficient command sequences are provided to the users utilizing the less effective approaches. The detected command sequence is stored in place of less efficient command sequences and where no prior command sequences has been previously stored.

The opinion classification system 302 adds into the driving history database 304 new kinds of driving behavioral descriptions that it may get from users. There can be behavioral driving characteristics that were not described and stored in the driving history database 304. For example, some states could introduce rules that don't allow drivers to eat while they are driving. Therefore eating by drivers in a car could become a new behavioral characteristics that should be characterized, classified and put into the driving history database 304. These new behavioral characteristics could be received from reports either directly from users who observed them and reported, or indirectly from sensors.

If the opinion classification system 302 finds that none of the stored driving behavioral characteristics in the driving history database 304 match some reported driving behavioral characteristics and that these reported behavioral driving characteristics significantly affect the driver safety or that they interfere with existing driving laws (e.g., drivers are not allowed to eat in cars), then the opinion classification system 302 adds these driver behavioral characteristics to the driving history database 304.

The opinion classification system 302 also stores a description of earlier driving behavioral disturbances that can be used for later evaluation of various drivers.

The voting system 303 uses metrics to collect opinions from different users about other drivers and to evaluate the behavior of these drivers at the wheel (e.g., very dangerous, dangerous, maybe dangerous, safe, etc.). The voting system 303 counts the total number of negative opinions concerning a particular driver divided by a period of time during which this opinion was expressed. In this sense, 5 negative opinions expressed during a time period of 10 years may have less value than 3 negative opinions expressed during the same week. More complex metrics are possible to evaluate a driver. Similarly, the voting system 303 can be used to evaluate different places.

As shown in FIG. 1, the remote traffic opinion server 102 forwards the resulting information to a decision taking unit 104, which then forwards the relevant information to the appropriate organizations. The decision taking unit 104 can send a warning message to the drivers who have been identified as being particularly dangerous. The decision taking unit 104 can also inform the police or insurance companies.

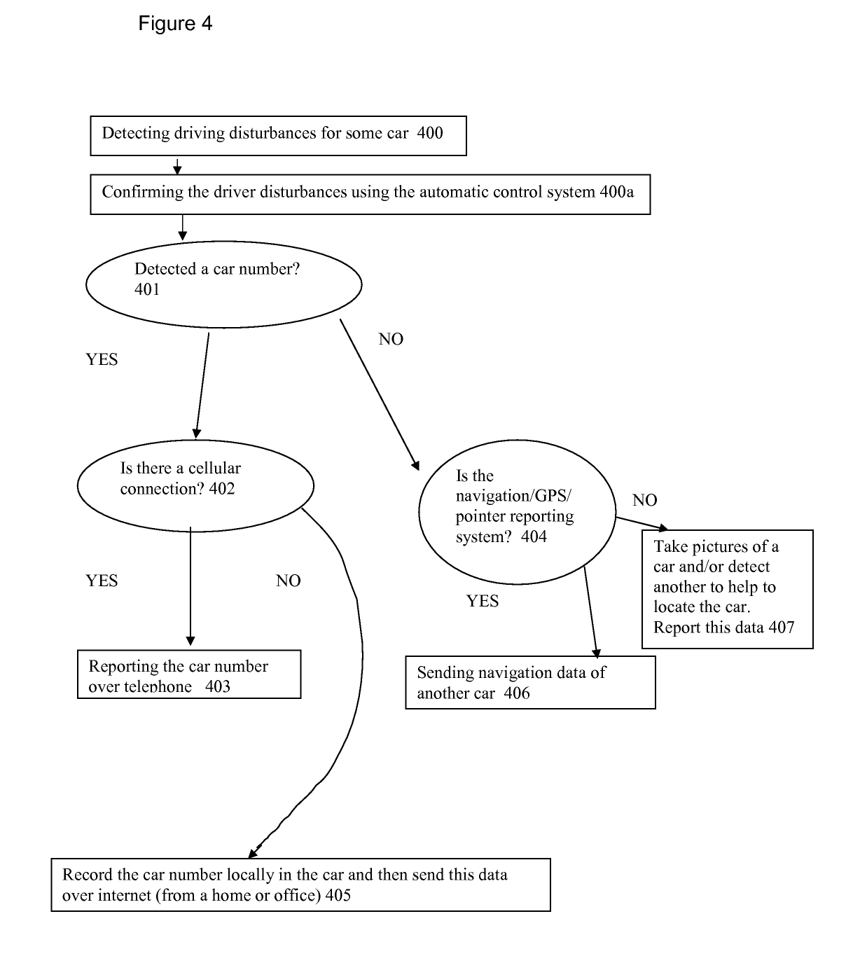

FIG. 4 shows processes carried out by an illustrative method according to an embodiment of the present. In 400, an abnormal situation on the road is detected (e.g., a car is speeding above 70 miles per hour). In 400a, the occurrence of this abnormal situation is confirmed using the event verifier system 103 (e.g., confirming that the car's speed is higher than 70 miles per hour).

In 401, the car which is at the origin of the abnormal situation is identified (e.g., is it possible for the driver to identify the car at the origin of the disturbance?). In 402, if the driver has identified the car at the origin of the disturbance, the driver checks to see if he/she has a mobile phone in their car. In 403, if the driver has a mobile phone in his/her car, the car number on the registration plate of the car is reported by means of this mobile phone. In 405, if the driver does not a mobile phone in his/her car, the car number is recorded locally and this data is sent later over the Internet (e.g., at home or the office).

In 404, if the driver has not identified the car at the origin of the disturbance, then the driver checks whether or not a navigation/GPS/reporting system is available. If the driver has not identified the car at the origin of the disturbance then the driver needs to use a different method to identify the car. For instance, a navigation/GPS/reporting system can be used to generate navigation data about another car (like its location, speed, and other characteristics). If a navigation/GPS/reporting system is available, navigation data of the car at the origin of the disturbance is sent in 406.

In 407, pictures are taken of the car and reported. If the car that is at the origin of the disturbance cannot be identified using the previously described means (e.g., by using GPS and pointer reporting system), then one can just take a picture of the car that is the origin of the disturbance and send this picture. This picture can be used later to identify this car, for example via a captured registration plate or from the driving history database 304 that may contain a similar picture of the car.

Some/all aspects of the present invention can be provided on a computer-readable medium that includes computer program code (e.g., a computer program product) for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

It should be appreciated that the teachings of the present invention could be offered as a business method on a subscription or fee basis. For example, a service provider can create, maintain, enable, and deploy an audience response detection interactive presentation tool, as described above.

While the invention has been particularly shown and described with reference to a preferred embodiment, it will be understood that various changes in form and detail may be made therein without departing from the spirit, and scope of the invention.

What is claimed is:

1. A method executed in a central traffic management system, for collecting, analyzing, and handling abnormal situations or abnormal vehicle behaviors encountered on a road by at least one vehicle, comprising:
receiving at least one report from at least one originator, each report corresponding to at least one abnormal situation or abnormal vehicle behavior encountered by a vehicle on the road;
for each received report:
for each reported abnormal situation:
characterizing the abnormal situation according to a situation type based on information and measurements contained in the report;
identifying and localizing the abnormal situation from information contained in the report;
taking an appropriate action in order to handle the abnormal situation based on:
the situation type,
the localization of the abnormal situation and
previous reports related to the abnormal situation, if any, received during a given time period;
for each reported abnormal vehicle behavior:
characterizing the abnormal vehicle behavior according to a behavior type based on information and measurements contained in the report;
identifying the vehicle or a driver of the vehicle having the abnormal behavior from information contained in the report;
taking an appropriate action based on:
the behavior type,
previous reports, if any, received during a given time period and concerning the same vehicle or driver;
recording the report.

2. The method according to claim 1, further comprising, for each report:
identifying the originator of the report.

3. The method according to claim 1, wherein receiving at least one report further comprises:
receiving a verbal description of the at least one abnormal situation or abnormal vehicle behavior using an interactive voice system.

4. The method according to claim 2, wherein identifying the originator of the report, further comprises:
recognizing a voice of the originator of the report using speech and language processing.

5. The method according claim 1, wherein reports are transmitted to the central traffic management system using wireless communications.

6. The method according claim 1, wherein receiving a report further comprises:
receiving:
a location of each abnormal situation or abnormal vehicle behavior;
a time and date corresponding to each abnormal situation or abnormal vehicle behavior; and
relevant information and measurements related to each abnormal situation or abnormal vehicle behavior.

7. The method according to claim 6, wherein measurements related to each abnormal situation or abnormal vehicle behavior comprise speed and/or distance measurements.

8. The method according to claim 1, wherein receiving a report further comprises:
verifying whether data received in the report is coherent.

9. The method according to claim 1, wherein the step of receiving a report further comprises:
receiving images related to the abnormal situation or abnormal vehicle behavior from a camera embarked in the vehicle.

10. The method according to claim 9, wherein receiving images related to an abnormal situation from a camera embarked in the vehicle further comprises:
identifying visual objects related to the abnormal situation using image processing.

11. The method according to claim 9, wherein receiving images related to an abnormal vehicle behavior from a camera embarked in the vehicle further comprises:
identifying the vehicle or a driver of the vehicle having the abnormal behavior.

12. The method according to claim 1, wherein taking an appropriate action for each reported abnormal vehicle behavior further comprises:
tracking the vehicle or driver behavior over a given period of time.

13. The method according to claim 1, wherein taking an appropriate action for each reported abnormal vehicle behavior further comprises:
forwarding to the driver or owner of the vehicle information about the reported abnormal vehicle behavior.

14. The method according to claim 1, wherein taking an appropriate action for each reported abnormal vehicle behavior further comprises:
forwarding to an appropriate organization information about the reported abnormal vehicle behavior.

15. The method according to claim 1, wherein taking an appropriate action in order to handle the abnormal situation further comprises:
forwarding to an appropriate organization information about the reported abnormal situation in order to prevent an accident.

16. A system for collecting, analyzing, and handling abnormal situations or abnormal vehicle behaviors encountered on a road by at least one vehicle, comprising:
a system for receiving at least one report from at least one originator, each report corresponding to at least one abnormal situation or abnormal vehicle behavior encountered by a vehicle on the road, the system for receiving being configured to:
for each received report:
for each reported abnormal situation:
characterizing the abnormal situation according to a situation type based on information and measurements contained in the report;
identifying and localizing the abnormal situation from information contained in the report;
taking an appropriate action in order to handle the abnormal situation based on:
the situation type,
the localization of the abnormal situation and
previous reports related to the abnormal situation, if any, received during a given time period;
for each reported abnormal vehicle behavior:
characterizing the abnormal vehicle behavior according to a behavior type based on information and measurements contained in the report;
identifying the vehicle or a driver of the vehicle having the abnormal behavior from information contained in the report;
taking an appropriate action based on:
the behavior type,
previous reports, if any, received during a given time period and concerning the same vehicle or driver;
recording the report.

17. A computer program product comprising instructions for collecting, analyzing, and handling abnormal situations or abnormal vehicle behaviors encountered on a road by at least one vehicle, when the computer program is executed on a computer system, the computer program product comprising program code for:
receiving at least one report from at least one originator, each report corresponding to at least one abnormal situation or abnormal vehicle behavior encountered by a vehicle on the road;
for each received report:
for each reported abnormal situation:
characterizing the abnormal situation according to a situation type based on information and measurements contained in the report;
identifying and localizing the abnormal situation from information contained in the report;
taking an appropriate action in order to handle the abnormal situation based on:
the situation type,
the localization of the abnormal situation and
previous reports related to the abnormal situation, if any, received during a given time period;
for each reported abnormal vehicle behavior:
characterizing the abnormal vehicle behavior according to a behavior type based on information and measurements contained in the report;
identifying the vehicle or a driver of the vehicle having the abnormal behavior from information contained in the report;
taking an appropriate action based on:
the behavior type,
previous reports, if any, received during a given time period and concerning the same vehicle or driver;
recording the report.
